(19) United States
(12) Patent Application Publication
(10) Pub. No.: US 2016/0119456 A1
(43) Pub. Date: Apr. 28, 2016

(54) RADIO FREQUENCY TRANSPARENT COVER PART AND APPARATUS

(71) Applicant: VERTU CORPORATION LIMITED, Hampshire (GB)

(72) Inventors: Stuart Godfrey, Hook (GB); Mark Potter, Basingstoke (GB)

(21) Appl. No.: 14/894,051

(22) PCT Filed: May 30, 2013
(86) PCT No.: PCT/EP2013/061140

§ 371 Date: Nov. 25, 2015

(51) Int. Cl. H04M 1/02; B29C 70/42; B29C 70/68; B29C 70/88

(52) U.S. Cl. CPC H04M 1/0202; B29C 70/88; B29C 70/42; B29C 70/68; B29K 2105/0809

(57) ABSTRACT

A cover part includes a radio frequency transparent woven fabric layer arranged within the cover part; and a radio frequency transparent coating layer arranged within the cover part, at least partially in contact with the radio frequency transparent woven fabric layer, the coating layer configured to change appearance of the cover part, wherein the cover part being configured to pass radio frequency signals through the cover part.

### TECHNICAL FIELD

The invention relates to cover parts, and particularly to radio frequency transparent cover parts used in mobile apparatuses.

### BACKGROUND ART

Portable apparatuses, such as mobile phones, tablets and personal computers have ever increasing demand for a high-speed data access. Furthermore, an antenna system of the apparatus may be arranged to operate in a plurality of different operational radio frequency bands and via a plurality of different protocols. For example, the different frequency bands and protocols may include (but are not limited to) Long Term Evolution (LTE) 700 (US) (698.0-716.0 MHz, 728.0-746.0 MHz), LTE 1500 (Japan) (1427.9-1452.9 MHz, 1475.9-1500.9 MHz), LTE 2600 (Europe) (2500-2570 MHz, 2620-2690 MHz), amplitude modulation (AM) radio (0.535-1.705 MHz); frequency modulation (FM) radio (76-108 MHz); Bluetooth (2400-2483.5 MHz); wireless local area network (WLAN) (2400-2483.5 MHz); helical local area network (HLAN) (5150-5850 MHz); global positioning system (GPS) (1570.42-1580.42 MHz); US-Global system for mobile communications (US-GSM) 850 (824-894 MHz); European global system for mobile communications (EGSM) 900 (880-960 MHz); European wideband code division multiple access (EU-WCDMA) 900 (880-960 MHz); personal communications network (PCN/DCS) 1800 (1710-1880 MHz); US wideband code division multiple access (US-WCDMA) 1900 (1850-1990 MHz); wideband code division multiple access (WCDMA) 2100 (Tx: 1920-1980 MHz Rx: 2110-2180 MHz); personal communications service (PCS) 1900 (1850-1990 MHz); ultra wideband (UWB) Lower (3100-4900 MHz); UWB Upper (6000-10600 MHz); digital video broadcasting—handheld (DVB-H) (470-702 MHz); DVB-H US (1670-1675 MHz); digital radio mondiale (DRM) (0.15-30 MHz); worldwide interoperability for microwave access (WiMax) (2300-2400 MHz, 2305-2360 MHz, 2496-2690 MHz, 3300-3400 MHz, 3400-3800 MHz, 5250-5875 MHz); digital audio broadcasting (DAB) (174.928-239.2 MHz, 1452.96-1490.62 MHz); radio frequency identification low frequency (RFID LF) (0.125-0.134 MHz); radio frequency identification high frequency (RFID HF) (13.56-13.56 MHz); radio frequency identification ultra-high frequency (RFID UHF) (433 MHz, 865-956 MHz, 2450 MHz).

With the ever increasing demand on different radio accesses, also the look and design of the mobile apparatus is of greater importance. Consumers may desire personalized and high-class design for their apparatuses. However, many of the materials suitable for high-class design are conductive. If such materials are used for a cover of the mobile apparatus comprising radio communication interface, the performance of the radio may be heavily affected. The conductive material may be radio frequency non-transparent and block the radio signals.

The radio performance degrades and may not meet design requirements. Thus, a cover part and an apparatus are needed to provide radio frequency functionality for a communication interface that is operable as an internal antenna of a mobile apparatus with an improved performance and outer design.

### SUMMARY

According to a first example aspect of the invention there is provided a cover part comprising:
a radio frequency transparent woven fabric layer arranged within the cover part; and
a radio frequency transparent coating layer arranged within the cover part, at least partially in an external surface of the radio frequency transparent woven fabric layer, the coating layer configured to change appearance of the cover part, wherein the cover part being configured to pass radio frequency signals through the cover part.

In an embodiment, the radio frequency transparent woven fabric layer is configured to provide mechanical strength for the cover part.

In an embodiment, the radio frequency transparent woven fabric layer is configured to provide decorative coverings for the cover part.

In an embodiment, the woven fabric layer comprises at least one of the following:
glass;
natural fibres;
quartz;
Kevlar; and
other aramid fibres.

In an embodiment, the coating layer comprises a non-conductive material.

In an embodiment, the coating layer comprising at least one of the following:
non-conductive vacuum metallization (NCVM);
diamond like carbon (DLC);
non-conductive ceramic;
paint comprising mica particles; and
RF transparent reflective paint.

In an embodiment, the radio frequency transparent coating layer being arranged on top of the radio frequency transparent woven fabric layer.

In an embodiment, the radio frequency transparent coating layer being arranged by applying coating to yarns of the radio frequency transparent woven fabric layer.

In an embodiment, the radio frequency transparent coating layer being arranged by applying coating to fibres of the yarns of the radio frequency transparent woven fabric layer.

In an embodiment, the coating layer being configured to change the appearance of the cover part by providing a metallic sheen to the cover part.

In an embodiment, the coating layer being configured to change the appearance of the cover part by adding distinctive colors to weaves of the woven fabric layer.

In an embodiment, the cover part further comprises:
a conductive layer arranged within the cover part.

In an embodiment, the cover part further comprises:
a through-portion not comprising the conductive layer, through which the cover part being configured to pass radio frequency signals through the cover part.

According to a second example aspect of the invention there is provided an apparatus comprising:
a communication interface for transceiving radio frequency signals;
a cover part protecting the communication interface; wherein
   a radio frequency transparent woven fabric layer arranged within the cover part; and
   a radio frequency transparent coating layer arranged within the cover part, at least partially in an external surface of the radio frequency transparent woven fabric layer, the coating layer configured to change appearance of the cover part, wherein the cover part being configured to pass radio frequency signals through the cover part.

In an embodiment, the radio frequency transparent woven fabric layer is configured to provide mechanical strength for the cover part.

In an embodiment, the radio frequency transparent woven fabric layer is configured to provide decorative coverings for the cover part.

In an embodiment, the communication interface comprises at least one antenna.

In an embodiment, the communication interface attached to a support element of the apparatus.

In an embodiment, the support element comprises at least one of a circuit board, a body part and a cover part of the apparatus.

According to a third example aspect of the invention there is provided a method for providing a cover part, the method comprising:
providing a radio frequency transparent woven fabric layer;
applying a radio frequency transparent coating layer, at least partially to an external surface of the radio frequency transparent woven fabric layer to provide a coated radio frequency transparent woven fabric layer; and
processing the coated radio frequency transparent woven fabric layer to provide the cover part, the coating layer configured to change appearance of the cover part, wherein the cover part being configured to pass radio frequency signals through the cover part.

In an embodiment, the method further comprises:
processing the coated radio frequency transparent woven fabric layer using pre-impregnated processing method.

In an embodiment, the method further comprises:
processing the coated radio frequency transparent woven fabric layer using resin transfer moulding method.

In an embodiment, the method further comprises:
providing the cover part using the processed coated radio frequency transparent woven fabric layer.

The cover part for the apparatus may be manufactured by moulding at least one of the woven fabric layer and the coating layer.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

The invention will be described, by way of example only, with reference to the accompanying drawings, in which:

FIG. 1 shows some details of a cover part arrangement in which various embodiments of the invention may be applied;

FIG. 2 shows some details of another cover part arrangement in which various embodiments of the invention may be applied;

FIG. 3 presents a schematic view of an apparatus in which various embodiments of the invention may be applied;

FIG. 4 presents an example block diagram of an apparatus in which various embodiments of the invention may be applied; and

FIG. 5 shows operations in an apparatus in accordance with an example embodiment of the invention.

### DETAILED DESCRIPTION

In the following description, like numbers denote like elements.

In an embodiment, a fibre reinforced polymer composite system that is both radio frequency (RF) transparent and has acceptable cosmetic looks is provided. Such outcome is achieved by applying a radio frequency (RF) transparent coating to a woven fibre fabric before it is manufactured into a composite part.

Composite materials such as carbon fibre reinforced polymers are ideal materials for mobile apparatuses. They are light weight so the mass of the apparatus is kept to a minimum while at the same time they are stiff so the apparatuses do not flex or bend when force is applied (i.e. during drop and tumble). Therefore the screen, LCD/OLED and internal electronics are protected from excess stresses, which improve product reliability.

In the demanding consumer market, such as luxury/premium market, carbon fibre composite is an accepted material as the woven carbon fibre fabric, combined with transparent polymer resins, produces a distinctive look. For this reason the carbon fibre material is often displayed without paint or other finishes so that the woven structure of the composite is clearly visible. For example top end sports cars and boats will often have natural carbon fibre visible. The downside of these carbon fibre composites for mobile devices is that the carbon fibres conduct and therefore the material blocks radio frequency (RF) signals.

Other polymer composite systems exist that are radio frequency (RF) transparent; these include glass fibre, quartz fibre, natural fibre, such as hemp or flax, Kevlar® or other aramid fibres. While these radio frequency (RF) transparent composite systems meet the mechanical requirement, they generally do not meet the cosmetic requirement. Compared to carbon fibre, these composite materials look very flat (i.e. lack depth) and the weave is not easily visible in the composite part.

The reason that carbon fibre looks acceptable in a composite part is partly because the carbon fibre itself has a slight metallic reflective surface; light is reflected from this surface of the woven fibre fabric and is therefore clearly visible

In an embodiment, radio frequency (RF) transparent woven fabric (such as glass, quartz or Kevlar® fabric) is used and radio frequency (RF) transparent, cosmetic coating is applied to the weave. The coating has two main requirements, it must be radio frequency (RF) transparent and it must improve or change the visual look of the weave. Coatings that could be used to achieve this include, but are not limited to non-conductive vacuum metallization (NCVM), diamond like carbon (DLC), paints systems such as mica containing paints, RF transparent reflective paints, or non-conductive ceramic coatings, for example.

Kevlar® is a material formed by combining para-phenylenediamine and terephthaloyl chloride. Aromatic polyamide (aramid) threads are the result. They are further refined, by dissolving the threads and spinning them into regular fibres. When woven, Kevlar® forms a strong and flexible material. If layers of the woven Kevlar® are combined with layers of resin, the resulting ‘rigid’ material is light and has twenty times the strength of steel. It is also superior to specialist metal alloys.

In an embodiment, a woven fibre fabric that is radio frequency (RF) transparent (i.e. Kevlar®, glass, quartz etc.) is applied with a non-conductive vacuum metallization (NCVM) coating to the weave. The coating is chosen so that it enhances the look of the underlying woven material making it more visible in the final composite product. The coating could either add a metallic sheen (for example to make flat looking black glass look more like carbon fibre) or it could be used to add distinctive colours to the weave.

In an embodiment, as well as applying the radio frequency (RF) transparent coating to woven materials, it could be possible to apply these coatings to individual yarns or the individual fibres within the yarn.

Embodiments of the invention will allow cosmetic, radio frequency (RF) transparent composites to be used in the construction of mobile apparatuses, such as phones, tablets, watches, PDA's and PC's, for example. The utilization of the different layers adds an improved cosmetic look to radio frequency (RF) transparent materials such as Kevlar®, glass or quartz without further affecting the radio frequency (RF) transparency of the material. Such development could be particularly relevant to high-end products as premium materials are key to such brand. As electronic technology develops and more antennae's are used on a product the ability to use conductive metals in cover parts of the apparatus gets reduced. Advanced, functional composites is one way that mobile apparatus can still utilize premium materials without sacrificing the functional performance of the wireless communication interface of the apparatus.

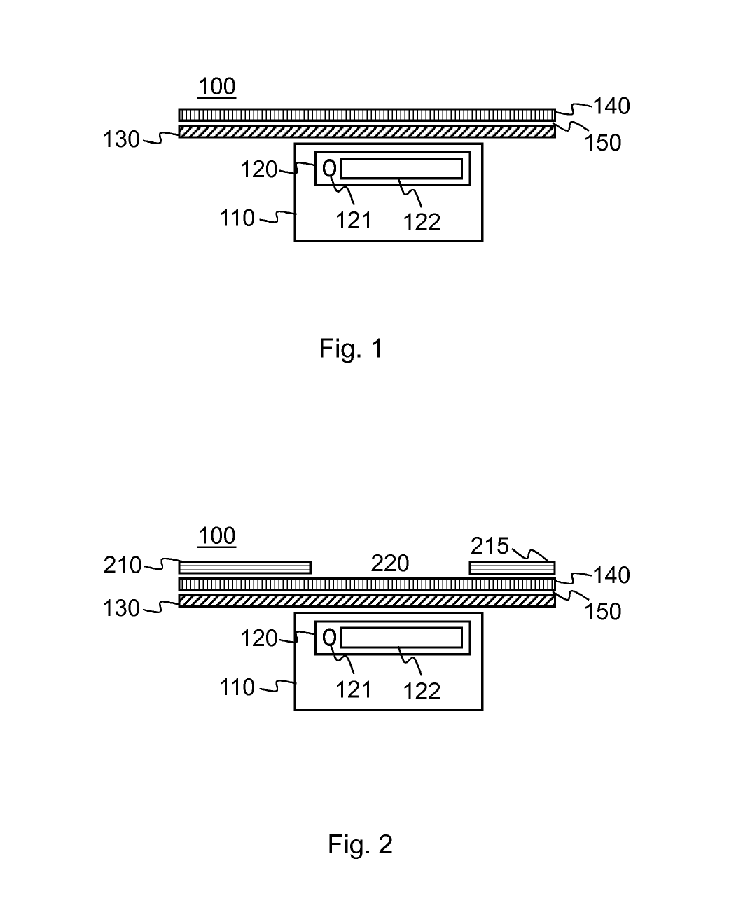

FIG. 1 shows some details of a cover part arrangement 100 in which various embodiments of the invention may be applied.

In an embodiment, a cover part arrangement 100 comprises a radio frequency (RF) transparent woven fabric layer 130 arranged within the cover part 100. The radio frequency (RF) transparent woven fabric layer 130 may be configured to provide mechanical strength for the cover part 100. The radio frequency (RF) transparent woven fabric layer 130 may also be configured to provide decorative coverings for the cover part 100. The cover part may be a non-structural part.

Furthermore, the cover part arrangement 100 comprises a radio frequency (RF) transparent coating layer 140 arranged within the cover part 100, at least partially in an external surface of the radio frequency (RF) transparent woven fabric layer 130, the coating layer configured to change appearance of the cover part 100, wherein the cover part 100 being configured to pass radio frequency signals through the cover part 100. The layers 130, 140 may be at least partially connected to each other or there may be, for example, an adhesive layer 150 between them.

In an embodiment, the cover part 100 is implemented in an apparatus comprising a wireless communication interface comprising a support element 110, such as a printed circuit board (PCB) or a body part of an apparatus. The wireless communication interface may further comprise an antenna 120 connected to a first feed point 121, comprising a radiator 122 configured to resonate in at least one frequency band. The antenna 120 may comprise several contact points and radiators, and their shapes may be different than shown in FIG. 1.

The antenna system may comprise a second antenna connected to a second feed point, comprising a second radiator configured to resonate in at least one frequency band. The frequency band of the second antenna may be the same as for the first antenna in at least one band or a different band.

The radio frequency (RF) signals of the wireless communication interface shall travel through the cover part arrangement 100.

In an embodiment, the cover part 100 comprises a layer 130 of a woven sheet of an aramid fiber, for providing a thin, durable, resilient and flexible material, which can be connected to the coating layer 140. In one embodiment, the aramid fiber can include a combination of woven fibers, such as Kevlar® with one or more of Nomex, Technora, Haracron and Twaron, for example. Aramids and para-aramid fibers can provide attractive properties, such as good strength-to-weight properties; high tenacity; low creep; and low elongation at break.

Kevlar® is the registered trademark for a para-aramid synthetic fiber, related to other aramids such as Nomex, Heracron and Technora. Developed at DuPont, this high strength material provides attractive properties, such as mentioned above.

Currently, Kevlar® has many applications, ranging from bicycle tires and racing sails to body armor because of its high tensile strength-to-weight ratio; by this measure it can be about five times stronger than steel on an equal weight basis. When used as a woven material, it is suitable for mooring lines and other applications, for example.

The woven fabric layer 130 may comprise at least one of the following: glass, quartz, and Kevlar.

The coating layer 140 may comprise a non-conductive material, such as non-conductive vacuum metallization (NCVM), diamond like carbon (DLC), paints systems such as mica containing paints, RF transparent reflective paints, and non-conductive ceramic, for example. The radio frequency transparent coating layer 140 is arranged on top of the radio frequency transparent woven fabric layer 130.

In an embodiment, the radio frequency transparent coating layer 140 may be arranged by applying coating to yarns of the radio frequency transparent woven fabric layer 130.

In an embodiment, the radio frequency transparent coating layer 140 is arranged by applying coating to fibres of the yarns of the radio frequency transparent woven fabric layer 130.

In an embodiment, the radio frequency transparent woven fabric layer 130 is configured to provide at least one of the following:
mechanical strength for the cover part; and
decorative coverings for the cover part.

In an embodiment, the coating layer 140 may be configured to change the appearance of the cover part 100 by providing a metallic sheen to the cover part 100, for example.

In an embodiment, the coating layer 140 may be configured to change the appearance of the cover part 100 by adding distinctive colors to weaves of the woven fabric layer 130, for example.

In an embodiment, the coating layer 140 may be configured to change the appearance of the cover part 100 by adding reflective elements to weaves of the woven fabric layer 130, for example.

In an embodiment, the coating layer 140 may be configured to change the appearance of the cover part 100 by adding different color shades to weaves of the woven fabric layer 130, for example.

In an embodiment, the coating layer 140 may be configured to change the appearance of the cover part 100 by adding different color tones to weaves of the woven fabric layer 130, for example.

In an embodiment, the coating layer 140 may be configured to change the appearance of the cover part 100 by adding three-dimensional elements to weaves of the woven fabric layer 130, for example.

FIG. 2 shows some details of a cover part arrangement 100 in which various embodiments of the invention may be applied.

In an embodiment, a cover part arrangement 100 comprises a radio frequency (RF) transparent woven fabric layer 130 arranged within the cover part 100, configured to provide mechanical strength for the cover part 100. Furthermore, the cover part arrangement 100 comprises a radio frequency (RF) transparent coating layer 140 arranged within the cover part 100, at least partially in an external surface of the radio frequency (RF) transparent woven fabric layer 130, the coating layer configured to change appearance of the cover part 100, wherein the cover part 100 being configured to pass radio frequency signals through the cover part 100. The layers 130, 140 may be at least partially connected to each other or there may be, for example, an adhesive layer 150 between them.

In an embodiment, the cover part arrangement 100 may comprise a further layer 210, 215. Such layer may be a conductive layer and thus radio frequency (RF) non-transparent and comprise metal elements, for example. The layer 210, 215 may be desired for improved look or design.

In an embodiment, the cover part 100 is implemented in an apparatus comprising a wireless communication interface comprising a support element 110, such as a printed circuit board (PCB) or a body part of an apparatus. The wireless communication interface may further comprise an antenna 120 connected to a first feed point 121, comprising a radiator 122 configured to resonate in at least one frequency band. The antenna 120 may comprise several contact points and radiators, and their shapes may be different than shown in FIG. 2.

The antenna system may comprise a second antenna connected to a second feed point, comprising a second radiator configured to resonate in at least one frequency band. The frequency band of the second antenna may be the same as for the first antenna in at least one band or a different band.

In an embodiment, a through-portion 220 in the conductive layer 210, 215 is provided. Such portion 220 does not comprise conductive element, and through which portion 220 the cover part being configured to pass radio frequency signals through the cover part 100.

The radio frequency (RF) signals of the wireless communication interface shall travel through the cover part arrangement 100.

In an embodiment, the cover part 100 comprises a layer 130 of a woven sheet of an aramid fiber, for providing a thin, durable, resilient and flexible material, which can be connected to the top layer 140. In one embodiment, the aramid fiber can include a combination of woven fibers, such as Kevlar® with one or more of Nomex, Technora, Haracron and Twaron, for example. Aramids and para-aramid fibers can provide attractive properties, such as good strength-to-weight properties; high tenacity; low creep; and low elongation at break.

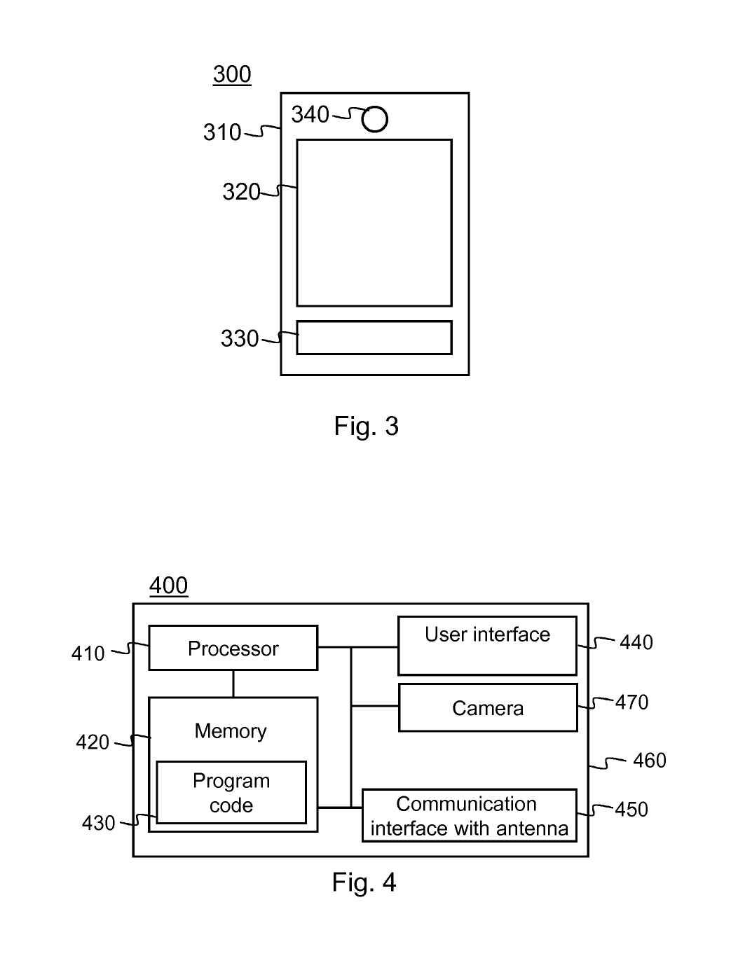

FIG. 3 presents a schematic view of an apparatus 300 in which various embodiments of the invention may be applied.

In an embodiment, the apparatus 300 may comprise a mobile phone, a smart phone, a tablet, a laptop or any other portable apparatus. The apparatus comprises at least one cover part 310 for providing protection to the components of the apparatus 300 and creating desired outlook and outer design for the apparatus 300. The cover part 310 may comprise several separate cover parts, such as front and rear covers and even a side frame. The apparatus 300 further comprises user interface 320, 330 comprising at least one display 320. The display 320 may be a touch-sensitive display for detecting user gestures and providing feedback for the apparatus 300. The apparatus 300 may also comprise a user input device 330, such as a keypad or a touchpad, for example. Furthermore, the apparatus 300 may comprise a camera 340. No matter the described elements 310, 320, 330, 340 are shown on the same side of the apparatus 300, they can be located on any side of the apparatus 300.

In an embodiment, at least a portion of element 310, such as a cover part, comprises a radio frequency transparent woven fabric layer arranged within the cover part. The cover part further comprises a radio frequency transparent coating layer arranged within the cover part, at least partially in an external surface of the radio frequency transparent woven fabric layer, the coating layer configured to change appearance of the cover part, wherein the cover part being configured to pass radio frequency signals through the cover part.

In an embodiment, the cover part 310 comprises a through-portion not comprising a conductive layer, through which portion the cover part 310 being configured to pass radio frequency signals through the cover part 310.

FIG. 4 presents an example block diagram of an apparatus 400 in which various embodiments of the invention may be applied. The apparatus 400 may be a user equipment (UE), user device or apparatus, such as a mobile terminal, a smart phone, a personal digital assistant (PDA), a laptop, a tablet or other communication device.

The general structure of the apparatus 400 comprises a user interface 440, a communication interface 450 including at least one antenna, a processor 410, a camera 470, and a memory 420 coupled to the processor 410. The apparatus 400 further comprises software 430 stored in the memory 420 and operable to be loaded into and executed in the processor 410. The software 430 may comprise one or more software modules and can be in the form of a computer program product. The apparatus 400 further comprises a cover part 460 to cover elements of the apparatus 400.

The processor 410 may be, e.g. a central processing unit (CPU), a microprocessor, a digital signal processor (DSP), a graphics processing unit, or the like. FIG. 4 shows one processor 410, but the apparatus 400 may comprise a plurality of processors.

The memory 420 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The apparatus 400 may comprise a plurality of memories. The memory 420 may be constructed as a part of the apparatus 400 or it may be inserted into a slot, port, or the like of the apparatus 400 by a user. The memory 420 may serve the sole purpose of storing data, or it may be constructed as a part of an apparatus serving other purposes, such as processing data.

The user interface 440 may comprise circuitry for receiving input from a user of the apparatus 400, e.g., via a keyboard, graphical user interface shown on the display of the user apparatus 400, speech recognition circuitry, or an accessory device, such as a headset, and for providing output to the user via, e.g., a graphical user interface or a loudspeaker. The display of the user interface 440 may comprise a touch-sensitive display.

The communication interface module 450 implements at least part of radio transmission. The communication interface module 450 may comprise, e.g., a wireless interface module. The wireless interface may comprise such as near field communication (NFC), a WLAN, Bluetooth, infrared (IR), radio frequency identification (RF ID), GSM/GPRS, CDMA, WCDMA, or LTE (Long Term Evolution) radio module. The communication interface module 450 may be integrated into the user apparatus 400, or into an adapter, card or the like that may be inserted into a suitable slot or port of the apparatus 400. The communication interface module 450 may support one radio interface technology or a plurality of technologies. The apparatus 400 may comprise a plurality of communication interface modules 450. The communication interface module 450 may comprise a multiple-input multiple-output (MIMO) antenna system comprising a first antenna connected to a first feed point, comprising a radiator configured to resonate in at least one frequency band; and a second antenna connected to a second feed point, comprising a radiator configured to resonate in at least one frequency band.

A skilled person appreciates that in addition to the elements shown in FIG. 4, the apparatus 400 may comprise other elements, such as microphones, displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the apparatus 400 may comprise a disposable or rechargeable battery (not shown) for powering when external power if external power supply is not available.

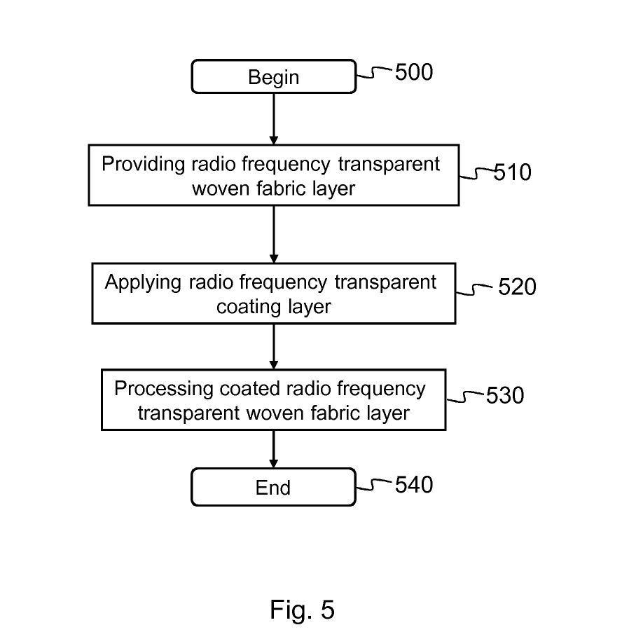

FIG. 5 shows operations in an apparatus in accordance with an example embodiment of the invention.

In step 500, a method for providing a cover part is started. In step 510, a radio frequency (RF) transparent woven fabric layer is provided. In step 520, a radio frequency (RF) transparent coating layer is applied, at least partially to an external surface of the radio frequency (RF) transparent woven fabric layer. The coating layer is configured to change appearance of the cover part, the cover part being configured to pass radio frequency (RF) signals through the cover part. In step 530, the coated radio frequency transparent woven fabric layer is processed to provide the cover part, the coating layer configured to change appearance of the cover part, wherein the cover part being configured to pass radio frequency signals through the cover part. In step 540, the method ends.

In an embodiment, a manufacturing process for radio frequency (RF) transparent cover part is provided.

Manufacturing of fibre reinforced composite materials is a multi-stage process that involves the combination of fibre based fabrics with different polymer resins to make a composite material.

The process starts with production of a radio frequency (RF) transparent woven fibre cloth. The cloth is normally woven from multi-filament strands or yarns of material. The structure of the yarn and the type of weave is normally used to describe the cloth so a “3 k 2-2 Twill carbon fibre fabric” is a fabric made from yarns that contain 3,000 (3 k) individual filaments of carbon woven into a 2-2 Twill pattern. The individual filaments in the yarn are very fine and are typically only 15 micrometre in diameter.

The radio frequency (RF) transparent woven fabric layer may comprise at least one of the following:
glass;
natural fibres;
quartz;
Kevlar; and
aramid fibres.

The fibres are normally chosen to suit a specific requirement. For example high strength, high stiffness carbon fibres are used to make light-weight, stiffness critical applications such as high performance cars, aerospace applications and sporting goods. Another example of specific use is Kevlar or Aramid fibres; these fibres are not particularly stiff but they are strong and tough and hence they are used for absorbing energy so are good in bullet proof or anti-stab composites.

The radio frequency (RF) transparent woven fabrics may then be combined with polymer resins by a number of methods to make a composite material, for example using pre-preg (pre-impregnated) lay-up or resin transfer moulding.

In an embodiment a coating layer comprising a non-conductive material is applied to the radio frequency (RF) transparent woven fabrics before pre-preg (pre-impregnated) lay-up or resin transfer moulding. The coating layer may comprise at least one of the following:
non-conductive vacuum metallization (NCVM);
paint comprising mica particles;
RF transparent reflective paint;
diamond like carbon (DLC); and
non-conductive ceramic.

In an embodiment, pre-preg lay-up may be used then to process the composite. The radio frequency (RF) transparent woven fibre cloths with the coating layer are infused with a thermosetting epoxy resin producing a cloth that is pre-impregnated with resin. This pre-preg cloth can then be cut to size and placed into a shaped mould. The mould is closed and then heat and pressure is applied to the pre-preg lay-up. During this heat and pressure cycle the resin completely infiltrates between the fibres and is cured (cross-linked) producing a solid fibre reinforced material. Because of the heated cure cycle processing times are generally long (hours) but the pre-preg method generally produces the highest quality composite material. This type of process is generally suited to low volume, high performance applications.

In an embodiment, resin transfer moulding (RTM) may be used to process the compound. In this case radio frequency (RF) transparent dry woven fibre cloth with the coating layer is cut to shape and then placed into a mould. Thermoplastic resin is then then melted and injected into the mould under pressure. The viscosity of the molten resin is such that it flows in between the fibres. Once the injection process is completed the mould is cooled so that the thermoplastic resin solidifies producing a solid part. Resin transfer moulding has similarities to plastic injection moulding and so part cycle times are shorter making the process more applicable to medium volume applications.

Other fabrication methods are used to produce composites and the two techniques mentioned above are just examples, other techniques may also comprise hybrid versions of the described above.

Various embodiments have been presented. It should be appreciated that in this document, words comprise, include and contain are each used as open-ended expressions with no intended exclusivity.

1. A cover part comprising:
a radio frequency transparent woven fabric layer arranged within the cover part; and
a radio frequency transparent coating layer arranged within the cover part, at least partially in an external surface of the radio frequency transparent woven fabric layer, the coating layer configured to change appearance of the cover part, wherein the cover part being configured to pass radio frequency signals through the cover part.

2. The cover part of claim 1, wherein the radio frequency transparent woven fabric layer is configured to provide at least one of the following:
mechanical strength for the cover part; and
decorative coverings for the cover part.

3. The cover part of claim 2, wherein the woven fabric layer comprises at least one of the following:
glass;
natural fibres;
quartz;
Kevlar; and
other aramid fibres.

4. The cover part of claim 2, wherein the coating layer comprises a non-conductive material.

5. The cover part of claim 4, wherein the coating layer comprises at least one of the following:
non-conductive vacuum metallization (NCVM);
paint comprising mica particles;
RF transparent reflective paint; diamond like carbon (DLC); and
non-conductive ceramic.

6. The cover part of claim 1, wherein the radio frequency transparent coating layer is arranged on top of the radio frequency transparent woven fabric layer.

7. The cover part of claim 6, wherein the radio frequency transparent coating layer is arranged by applying coating to yarns of the radio frequency transparent woven fabric layer.

8. The cover part of claim 7, wherein the radio frequency transparent coating layer is arranged by applying coating to fibres of the yarns of the radio frequency transparent woven fabric layer.

9. The cover part of claim 1, wherein the coating layer is configured to change the appearance of the cover part by providing a metallic sheen to the cover part.

10. The cover part of claim 1, wherein the coating layer is configured to change the appearance of the cover part by adding distinctive colors to weaves of the woven fabric layer.

11. The cover part of claim 1, wherein the cover part further comprises:
a conductive layer arranged within the cover part; and
a through-portion not comprising the conductive layer, through which the cover part being configured to pass radio frequency signals through the cover part.

12. (canceled)

13. An apparatus comprising:
a communication interface for transceiving radio frequency signals; and
a cover part protecting the communication interface; wherein the cover part comprises:
a radio frequency transparent woven fabric layer arranged within the cover part; and
a radio frequency transparent coating layer arranged within the cover part, at least partially in an external surface of the radio frequency transparent woven fabric layer, the coating layer configured to change appearance of the cover part, wherein the cover part being configured to pass radio frequency signals through the cover part.

14. The apparatus of claim 13, wherein the radio frequency transparent woven fabric layer is configured to provide at least one of the following:
mechanical strength for the cover part; and
decorative coverings for the cover part.

15. The apparatus of claim 13, wherein the communication interface comprises at least one antenna.

16. A method for providing a cover part, the method comprising:
providing a radio frequency transparent woven fabric layer;
applying a radio frequency transparent coating layer, at least partially to an external surface of the radio frequency transparent woven fabric layer to provide a coated radio frequency transparent woven fabric layer; and
processing the coated radio frequency transparent woven fabric layer to provide the cover part, the coating layer configured to change appearance of the cover part, wherein the cover part being configured to pass radio frequency signals through the cover part.

17. A method of claim 16, further comprising:
processing the coated radio frequency transparent woven fabric layer using pre-impregnated processing method.

18. A method of claim 16, further comprising:
processing the coated radio frequency transparent woven fabric layer using resin transfer moulding method.

19. A method of claim 16 further comprising:
providing the cover part using the processed coated radio frequency transparent woven fabric layer.

20. The method of claim 16, the method further comprising:
infusing radio frequency (RF) transparent woven fibre cloths and the coating layer with a thermosetting epoxy resin producing a cloth that is pre-impregnated with the thermosetting epoxy resin;
cutting said pre-impregnated cloth to size and placing into a shaped mould; and
closing the mould, heating and applying pressure to the pre-impregnated cloth, wherein during this heat and pressure cycle the resin infiltrates between the fibres and is cured producing a solid fibre reinforced material.

21. The method of claim 18, the method further comprising:
cutting radio frequency (RF) transparent dry woven fibre cloth with the coating layer to shape and placing into a mould;
melting and injecting thermoplastic resin into the mould under pressure, wherein viscosity of the molten resin is such that the resin flows in between fibres of the dry woven fibre cloth; and
cooling the mould after injection process is completed so that the thermoplastic resin solidifies producing a solid part.
